(19) United States
(12) Patent Application Publication
(10) Pub. No.: US 2018/0023777 A1
(43) Pub. Date: Jan. 25, 2018

(54) VEHICLE HEADLAMP

(71) Applicant: VALEO VISION, Bobigny Cedex (FR)

(72) Inventor: Christine ROUCOULES, Bobigny Cedex (FR)

(73) Assignee: VALEO VISION, Bobigny Cedex (FR)

(21) Appl. No.: 15/656,637

(22) Filed: Jul. 21, 2017

(30) Foreign Application Priority Data
Jul. 22, 2016 (FR) 16 57059

(51) Int. Cl. F21S 8/10; F21V 29/51; B60Q 1/068; F21V 29/58

(52) U.S. Cl. CPC F21S 48/326; F21S 48/1742; F21V 29/59; F21V 29/51; F21S 48/1225; F21S 48/1109; B60Q 1/068

(57) ABSTRACT

The invention relates notably to a vehicle headlamp including at least one housing, at least one supporting element for a light source located inside the housing, a system for adjusting the position of the light source in relation to the vehicle, and a system for evacuating heat from the inside of the housing to the outside of the housing. The invention thus provides an improved headlamp.

### DOMAIN OF THE INVENTION

The invention relates to the domain of vehicle headlamps, i.e. devices designed to project light in order to illuminate the road and/or to make the vehicle more visible when the vehicle is being driven, such as position lamps or high and/or low beam (commonly referred to as headlamps).

### BACKGROUND

Vehicle headlamps include a housing containing different components, including a light source during use of the headlamp. At least some of the different components generate heat when in use, which raises the temperature of the components, which may damage the components and/or impede the optimum use thereof. Different solutions attempt to address this problem, such as the solutions described in document US 2011310631 A, in document US 2006076572 A, in document US 20100296308 A, in document DE 102011120123 A1, in document US 2015168555 A, in document CN 103807719 A, and in document CN 203823623 U.

However, the aforementioned solutions are not ideal, notably in relation to the evolution of the performance levels of modern headlamps and the quantity of heat generated by the components thereof, and the heat around the components inside the housing is therefore not adequately dissipated.

### SUMMARY OF THE INVENTION

A vehicle headlamp including at least one housing, at least one light-source supporting element located inside the housing, a system for adjusting the position of the light source in relation to the vehicle, and a system for evacuating heat from the inside of the housing to the outside of the housing is therefore proposed.

According to different embodiments, the headlamp may include one or more of the following characteristics, combined with one another:
the heat evacuation system includes a flexible heat communication system,
the heat evacuation system includes at least one fluid heat exchanger and one heat communication system linking the light-source supporting element and the fluid heat exchanger,
the fluid heat exchanger is a liquid heat exchanger,
the fluid heat exchanger includes a connection system to a cooling circuit,
the cooling circuit is a low-temperature cooling loop of the vehicle,
the fluid heat exchanger includes a cold plate,
the cold plate is located outside the housing or forms a wall of the housing,
the fluid heat exchanger is static in relation to the vehicle, while the heat communication system is flexible,
the fluid heat exchanger is static in relation to the light-source supporting element, while the heat communication system is flexible or rigid,
the heat communication system includes a heat pipe and/or a fluid circulation circuit, and/or
the headlamp includes two light-source supporting elements, both of the light-source supporting elements being positioned inside a single housing or each being positioned inside a respective housing, and/or the headlamp includes a fluid heat exchanger common to both light-source supporting elements or a separate fluid heat exchanger for each light-source supporting element.

### SHORT DESCRIPTION OF THE FIGURES

Other features and advantages of the invention are set out in the detailed description of the invention below, given as an example and with reference to the attached drawings, in which:

FIG. 1 is a schematic view of an example of the light-source supporting element with a light source mounted on the supporting element, and

FIGS. 2 to 5 are schematic views of different examples of the headlamp.

### DETAILED DESCRIPTION

A vehicle headlamp is proposed, along with a land vehicle including one or more versions of such a headlamp (for example two versions at the front for a four-wheeled vehicle, or one or two versions at the front for a two- or three-wheeled vehicle), for example according to one or more of the different integration methods described below. The headlamp includes at least one housing and at least one light-source supporting element located inside the housing. The headlamp may therefore also include such a light source, for example one light source mounted on each respective supporting element, the light-source supporting element being used for the assembly and functional travel of a light source inside the housing to enable illumination when the headlamp is in use (such assembly may be carried out at any time, for example in factory and/or subsequently). The headlamp also includes a system for adjusting the position of the light source in relation to the vehicle, which means that the position of the illumination is not permanently fixed in factory and is easy to change subsequently. Where there are multiple supporting elements and therefore multiple light sources, the headlamp includes such an adjustment system for each supporting element since the position of the light source is designed to be adjusted in relation to the vehicle, or a shared adjustment system for all such supporting elements. In both cases, adjustment may be carried out independently or interdependently (for example rigidly) for all of these light sources. The headlamp also includes a system for evacuating heat from inside the housing to outside the housing.

Such an arrangement with such a heat evacuation system in a headlamp in which the position of the illumination can be adjusted in relation to the vehicle enables efficient dissipation of the heat generated that is present around the components when the headlamp is in use. This reduces damage to the components inside the housing (including the light-source supporting element and the light source), thereby optimizing use of these components, in particular given that the light sources of the vehicle headlamps provide optimum illumination when the temperature is relatively low.

The vehicle may be any type of land vehicle, such as a motorcar, a motorcycle or a truck. The headlamp includes attachment means, for example by interlocking or embedding, in a zone of the vehicle provided for this purpose. The size, mechanical characteristics and/or rigidity of the attachment of the attachment means are adjusted to the type of motor vehicle and/or the speeds reached by the vehicle. The zone (or framework) of the vehicle that is designed to receive the headlamp can form a shell about the headlamp to protect the headlamp from the heat of the engine. The headlamp has at least one non-opaque portion (which may include a lens) of the housing, such that once said attachment is made, the light emitted by the light source can be projected towards the outside of the housing, such as to illuminate the road when driving.

Furthermore, the headlamp includes a housing with means forming, at least after such an attachment, an enclosure that contains the housing and therefore the light-source supporting element, as well as the light source mounted on the supporting element, where applicable. For example, the headlamp includes a closed sealed wall, the inside of the housing thus forming the sealed enclosure itself. In another example, the housing includes an open sealed wall that may be linked sealingly to a sealed surface of the zone of the vehicle that is designed to receive the headlamp and that matches the shape of the opening in the wall. In all cases, at least after attachment of the headlamp, the inside of the housing forms a volume that is sealed from the outside, such that the components therein (such as the light-source supporting element and, where applicable, the light source) are protected from the outside, in particular from the rain and/or impurities.

As specified above, there are different solutions in the prior art for dissipating heat from the components inside the housing that evacuate the heat during use of same, in particular the light source and the supporting element thereof. However, the existing solutions primarily involve moving the heat towards a colder zone of the housing. The aforementioned sealing results in the heat given off by the components being contained inside the housing, although said heat is moved to other zones of the housing. The accumulated heat inside the housing may then become too high.

In addition to or instead of these solutions, it is proposed that the light also includes a system for evacuating heat from inside the housing to outside the housing. This evacuation system may be any system that moves at least some heat towards the outside of the housing, such a heat flow being strictly greater (in terms of intensity) than the simple flow resulting from natural convection and heat exchange through the walls of the housing. Such an architecture of the headlamp thereby improves dissipation of the heat generated by the components of same away from said components, and at a lower cost in terms of material complexity and therefore installation of the headlamp.

Furthermore, the headlamp includes a system for adjusting the position of the light source in relation to the vehicle. Such an adjustment system enables the horizontal and/or vertical adjustment of the light beam generated by the light source of the headlamp. Adjustment may be carried out by actuating different mechanical elements. For example, the adjustment system of the headlamp may include mechanical positioning elements linked to the supporting elements of all of the position-adjustable light sources. In this case, the housing may be designed to be mounted on the vehicle statically in relation to the vehicle, and the light sources may each be static (i.e. in a non-adjustable position) in relation to the respective supporting elements. The mechanical positioning elements may then be configured to adjust the position of the supporting elements (independently or interdependently, for example rigidly, i.e. when the position of a supporting element is changed, the position of the other rigidly connected supporting element or elements changes by the same amount), such as to indirectly adjust the position of the light source and therefore of the light beam projected.

The proposed improvement to heat dissipation is especially useful if the headlamp includes a system for adjusting the position of the light source in relation to the vehicle.

The heat evacuation system may include a flexible heat communication system. The flexible heat communication system may be any element (e.g. defining a portion) of the heat evacuation system that provides mechanical flexibility and that is designed to communicate the heat over a distance. When the headlamp is mounted on the vehicle, the heat evacuation system can form an evacuation path for the heat from a point A inside the housing where same is generated (for example the light-source supporting element) to a point B outside the housing that is static in relation to the vehicle. As discussed below, point B may for example be a point linked to and static in relation to a fluid heat exchanger, such as a liquid heat exchanger, which is in turn static in relation to the vehicle and/or any mechanical element that is static in relation to the vehicle, for example a cooling circuit of the vehicle. In this case, the heat may be evacuated via a fluid heat exchanger, as mentioned above, that is for example on the evacuation path of the heat between point A and point B, in which case the exchanger need not be static, i.e. the exchanger may be free to move flexibly in relation to the vehicle. The flexibility of the heat communication system ensures that the heat evacuation system does not hinder the freedom of movement of the light source (which is for example static in relation to point A) in relation to the vehicle, which is required to adjust the position of the light source in relation to the vehicle.

Such a flexible heat communication system may include at least a portion of a heat communication system that links the light-source supporting element and the fluid heat exchanger, for example a liquid heat exchanger (as discussed above), for example a flexible heat pipe or a fluid circulation circuit (for example a liquid circulation circuit) that is flexible (for example at least two flexible hoses). Alternatively or additionally, the flexible heat communication system may include at least a portion of a connection system (for example a heat exchanger) to a cooling circuit of the vehicle, for example a fluid circulation circuit (for example a liquid circulation circuit) that is flexible (for example at least two flexible hoses).

The headlamp may include a light source used as a position headlamp, a light source used for low beam, a light source used for high beam, and/or one or more light sources performing any combination of the aforementioned functions. In one example, the headlamp includes a light source used as a position headlamp and a light source used both for low beam and for high beam.

Indeed, more recent versions of these types of headlamps, which require—in particular for legal reasons—that the user be able to adjust the position after manufacture (unlike fog lamps, for which the position is set in factory), have a relatively high number of electronic components concentrated in the same place, in particular close to the light source. Furthermore, the electronic components and the light source thereof may be relatively powerful and therefore dissipate a relatively large amount of heat. Moreover, correct operation of the light source thereof may be particularly sensitive to ambient temperature.

For example, the headlamp may include processing electronics inside the housing, for example built into a module also incorporating the supporting element or built into the light-source supporting element itself. The processing electronics may have a code function, a route function and/or an anti-glare function for road driving. Additionally or alternatively, the supporting element may be designed to enable assembly of one or more light sources comprising a system of light emitting diodes, and the supporting element may be designed to operate at an energy density greater than 50 mW/cm², for example around 100 mW/cm². The system for evacuating heat from the inside of the housing to the outside of the housing is therefore particularly useful since the system addresses the problem of heat being concentrated inside the housing, which is particularly undesirable in the specific context of such a headlamp, where conventional cooling means (such as a radiator cooled by natural convection) are insufficient. Indeed, a problem in this context is that the confinement of the light source and the electronic components performing multiple driver-assistance functions related to basic signaling functions (position headlamps, such as indicators) cause the ambient air to regularly exceed temperatures of 80° C. under extreme external temperature conditions for dissipated power levels exceeding 50 W. To achieve an optimal optical flow, the temperature inside the housing should be within the external temperature range of 35-70° C. as often as possible. The heat evacuation system may be designed to ensure this, while complying with the specific constraints of the headlamp (i.e. position adjustment possible, no dust, and no contamination of the optical module from the external environment).

In one example, the headlamp includes an optical module that includes a semiconductor wafer, for example made of silicon, with one or more zones designed to receive a light source, comprising one or more lighting sources larger than 1 mm², the wafer also including an integrated circuit, for example an application-specific integrated circuit (ASIC). The wafer may be attached to a heat sink. The heat sink may be made of a material with high thermal conduction or a flat heat pipe. The assembly comprising the wafer, the integrated circuit and the heat sink (where present) thus form one or more light-source supporting elements.

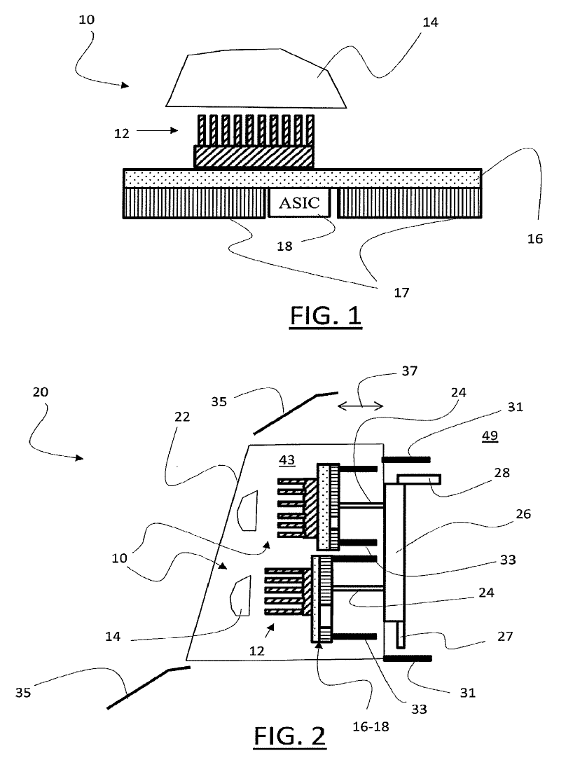

FIG. 1 is a schematic view of an optical module 10 according to this example. The optical module 10 includes a light source 12 comprising a three-dimensional (3D) diode system, a lens 14 which may cooperate with the light source 12 to generate a light beam, a silicon wafer including a zone 16 designed to receive a light source (the zone 16 receiving the light source 12 in the example in the figure) and a zone 17 comprising a conductive element that may be provided with micro heat pipes forming a heat sink. The micro heat pipes are particularly efficient in terms of heat dissipation. The zone 17 is provided with micro heat pipes or a heat pipe that may be connected to form a circuit enabling the heat to be communicated (i.e. conducted) to outside the supporting element, for example by connecting to the heat communication (or conduction) system mentioned below. Alternatively, the zone 17 may form a heat sink in another manner, for example using an integrated liquid circuit, or natural convection. Such examples are simple to carry out. The wafer also incorporates the integrated circuit 18. The assembly 16-18 in the example thus forms a supporting element designed for assembly of a single light source on the mechanical plate receiving the adjustment mechanism, but this mechanical plate may be designed to receive several light sources in a conventional manner.

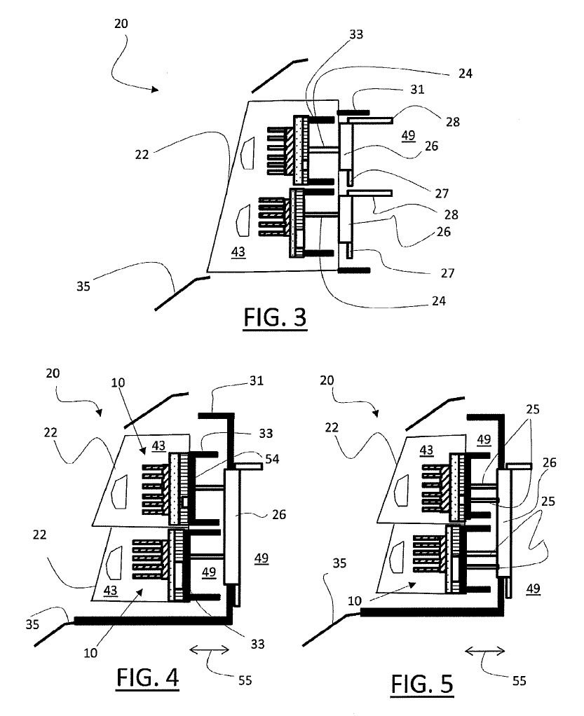

Different examples of the headlamp are discussed below with reference to FIGS. 2 to 5.

FIGS. 2 to 5 all show a different example of a vehicle headlamp 20 as described above, including at least one housing 22 (a single housing 22 in the example in FIGS. 2 and 3, and two separate housings 22 in the example in FIGS. 4 and 5), including two optical modules 10 according to the example described with reference to FIG. 1 (one optical module 10 per housing in the case of FIGS. 4 and 5). In all of the examples shown in FIGS. 2 to 5, the heat evacuation system includes at least one fluid heat exchanger 26-28, for example a cold-plate liquid heat exchanger, possibly with heat spreading by micro heat pipe and/or radiator. A fluid heat exchanger may be a system designed to transfer heat energy from a solid by circulation of a fluid towards an exchanger. Such a cold plate linked to a heat exchanger enables good dissipation of the heat generated in the housing 22, and notably better heat evacuation than convection (including forced convection).

In particular and as already indicated with reference to FIG. 1, each module 10 is fitted with a heat conducting element 17 designed to dissipate and/or spread the heat generated by the module, as is well known in the domain of power electronics. The conductive element 17 dissipating/spreading the heat is connected to a heat communication (or conduction) system 24 or 25 that carries said heat to the cold-plate heat exchanger 26-28. The heat communication system 24,25 thus links the light-source supporting element 16-18 and the heat exchanger 26-28 such as to evacuate the heat generated and/or stored by the light-source supporting element 16-18 (heat that therefore is in the inside 43 of the housing 22) towards the outside 49 of the housing. Indeed, as shown in FIGS. 2 to 5, the heat exchanger 26-28 is located on the outside 49 of the housing 22.

In the examples in the figures, the fluid heat exchanger in particular includes a cold plate 26 (i.e. a plate that can be cooled by a cooling circuit, also referred to as a cooling plate). This well known type of heat exchanger (for example liquid heat exchangers) is simple to build and is particularly suited, in terms of shape and mechanical characteristics, to such an application in a vehicle headlamp. The cold plate 26 is therefore located (at least partially, i.e. fully or partially) on the outside 49 of the housing 22, thereby making evacuation of the heat particularly efficient. In the example in FIGS. 2 and 3, the plate 26 is attached to the back of the housing 22 (relative to the direction of the light beam). This arrangement improves the mechanical rigidity of the assembly and simplifies installation of the headlamp 20, since the plate 26 can be preassembled with the housing 22, and the assembly can then be fitted into the appropriate zone of the vehicle. With this arrangement, the plate 26 can alternatively form a wall (for example the back wall) of the housing 22. In the example in FIGS. 4 and 5, the plate 26 is removed from the back of the housing 22 by a distance 55, and said back of the housing 22 is pressed against a corresponding supporting plate 54 of the vehicle. This arrangement enables the formation of an air gap between the cold plate 26 and the housing that acts as a thermal insulant, thereby reducing the thermal effect from the outside 49 towards the housing 22.

In the example in the figures, each heat exchanger also includes a fluid inlet 27 (for example a liquid inlet) and a fluid outlet 28 (for example a liquid outlet). This enables the heat exchanger to be linked to a cooling circuit (for example a liquid cooling circuit). The fluid in the cooling circuit thus keeps the plate 26 of the exchanger at a low temperature, continuously evacuating the heat inside the housing 22. In particular, in one example, the cooling circuit may be a cooling circuit of the vehicle, which makes the device simple to build and optimizes resource management (instead of developing a dedicated circuit). Compared to conventional headlamps without such a heat evacuation system, installation of the headlamp 20 in these examples only requires the additional step of linking the plate or plates 26 to the cooling circuit in question, using the connection system including the inlet or inlets 27 and the outlet or outlets 28 (which may be flexible, and/or the connection system may also include a fluid circulation circuit, that is for example flexible, for example pipes linked to the cooling circuit). Thus, the heat exchanger in the examples in the figure can be powered by the cooling loop at low temperature (less than 90° C.) or high temperature or both, depending on the thermal adjustment requirements. A connection to the cooling circuit formed by the low-temperature cooling loop of the vehicle (well known and generally present, notably on all electric and hybrid vehicles) helps to keep the temperature of the fluid for example at a maximum temperature of around 45° C.

The headlamp 20 in the examples therefore enables the heat to be dissipated to the outside 49 of the housing 22, for example using the cooling loops already present in the vehicle (FIGS. 4 and 5). Since the headlamp 20 is in a smaller volume, the inside 43 of the housing 22 is at a uniform temperature. This helps to limit the presence of a cold zone on the outer lens, which could create a risk of condensation. Furthermore, the arrangement in the examples also enables inclusion of a cooling circuit outside the housing 22, which limits the risk of generating pollution inside the headlamp 20, for example in the event of a leak. This also facilitates repairs. Combining with an existing cooling loop helps to reduce the weight of the headlamp 20 by obviating the need for a cooling system inside the headlamp.

The housing 22 in the examples therefore contains several optical modules 10 (precisely two, one acting as position headlamp and the other acting as high and/or low beam) linked to a liquid-cooled exchanger (cold plate). The fluid heat exchanger may be built as a single assembly (i.e. with a single plate 26 to which all the optical modules are connected), as is the case in the example in FIGS. 2, 4 and 5, or alternatively in several sub-assemblies (i.e. with several plates 26, each module 10 being linked to a respective plate 26, and each plate 26 having a respective inlet 27 and a respective outlet 28), as is the case in the example in FIG. 3. In FIGS. 4 and 5, the modules do not require adjustment in relation to one another inside the housing. Adjustment is carried out directly by the adjustment system outside the housing 22 in a conventional manner.

FIGS. 4 and 5 show an example enabling the effect of mutual heating between modules to be reduced. In this example, the modules 10 are defined as sealed products with their own housing 22 and their own adjustment system assembled on a structure. Each of the modules 10 is linked as described above to a cold plate 26. The cold plate 26 is shared by the modules in the examples. However, there may be one cold plate 26 per module 10, and therefore per housing 22, as explained with reference to FIG. 3. Such an individual plate 26 for each module could be pressed against the back of the housing 22 as in the example in FIG. 3, or be arranged at a distance 55, between the plate 26 and the supporting plate 54.

In all of the examples shown in the figures, the headlamp is mounted on the vehicle using mechanical elements 31 that are static in relation to the shell/framework 35 of the vehicle and to mechanical elements 33 (as well as the plate 54 in the examples in FIGS. 4 and 5) the position of which is adjustable in relation to the shell/framework 35 of the vehicle. The elements 33 belong to the system for adjusting the position of the light source in relation to the vehicle, the other elements of which are not shown in the figures for the sake of clarity. In the examples, these other elements nonetheless require a minimum clearance (i.e. the distance 37 shown in FIG. 2 only) between the supporting elements 16-18 and the cold plate 26 (for example greater than 1 cm, for example around 2 cm). Thus, in the examples in FIGS. 2 and 3, the position of the modules 10 can be adjusted in relation to the vehicle inside the shared housing 22 thereof, the shared housing 22 being itself static in relation to the vehicle. Conversely, in the examples in FIGS. 4 and 5, the position of the respective housing 22 of an individual module 10 is adjustable in relation to the vehicle, the respective module 10 of each housing 22 being static in relation to the respective housing 22.

In all of the examples shown in the figures, the heat exchanger or exchangers 26-28 are static in relation to the vehicle. Consequently, the heat communication system 24, 25 shown can be flexible, which helps to ensure the mobility of the supporting elements 16-18. If conversely the heat exchanger is static in relation to the light-source supporting element 16-18 (which is a possible alternative to the examples in the figures), the heat communication system 24, 25 shown could be flexible or rigid, and the flexibility in relation to the vehicle could then, in the case of a rigid heat communication system 24, 25, be provided by a flexible portion of the connection system to a cooling circuit of the vehicle, for example the inlet 27 and the outlet 28 or the elements connecting same, as explained above.

In the examples in FIGS. 2 to 4, the heat communication system is a heat pipe 24. This enables particularly efficient communication/conduction of heat from each supporting element 16-18 to the corresponding cold plate 26. Furthermore, the heat pipe 24 can be easily made flexible, thereby enabling adjustment of the position of the supporting element 16-18, where necessary. Unlike in these examples, FIG. 5 shows the alternative (instead of using a heat pipe 24 linked to the cold plate) of building a dual-inlet liquid exchange 25-28 with a liquid circuit 25 for cooling each module and the external circuit 27-28 mentioned above.

1. Vehicle headlamp including at least one housing, at least one supporting element for a light source located inside the housing, a system for adjusting the position of the light source in relation to the vehicle, and a system for evacuating heat from the inside of the housing to the outside of the housing.

2. Headlamp according to claim 1, wherein the heat evacuation system includes a flexible heat communication system.

3. Headlamp according to claim 1, wherein the heat evacuation system includes at least one fluid heat exchanger and one heat communication system linking the light-source supporting element and the fluid heat exchanger.

4. Headlamp according to claim 3, wherein the fluid heat exchanger is a liquid heat exchanger.

5. Headlamp according to claim 3, wherein the fluid heat exchanger includes a connection system to a cooling circuit.

6. Headlamp according to claim 5, wherein the cooling circuit is a low-temperature cooling loop of the vehicle.

7. Headlamp according to claim 3, wherein the fluid heat exchanger includes a cold plate.

8. Headlamp according to claim 7, wherein the cold plate is located outside the housing or forms a wall of the housing.

9. Headlamp according to claim 3, wherein the fluid heat exchanger is static in relation to the vehicle, while the heat communication system is flexible.

10. Headlamp according to claim 3, wherein the fluid heat exchanger is static in relation to the light-source supporting element, while the heat communication system is flexible or rigid.

11. Headlamp according to claim 2, wherein the heat communication system includes a heat pipe and/or a fluid circulation circuit.

12. Headlamp according to claim 1, wherein the headlamp includes two light-source supporting elements, both of the light-source supporting elements being positioned inside a single housing or each being positioned inside a respective housing, the headlamp including a fluid heat exchanger common to both light-source supporting elements or a separate fluid heat exchanger for each light-source supporting element.

13. Headlamp according to claim 2, wherein the heat evacuation system includes at least one fluid heat exchanger and one heat communication system linking the light-source supporting element and the fluid heat exchanger.

14. Headlamp according to claim 4, wherein the fluid heat exchanger includes a connection system to a cooling circuit.

15. Headlamp according to claim 4, wherein the fluid heat exchanger includes a cold plate.

16. Headlamp according to claim 4, wherein the fluid heat exchanger is static in relation to the vehicle, while the heat communication system is flexible.

17. Headlamp according to claim 4, wherein the fluid heat exchanger is static in relation to the light-source supporting element, while the heat communication system is flexible or rigid.

18. Headlamp according to claim 3, wherein the heat communication system includes a heat pipe and/or a fluid circulation circuit.

19. Headlamp according claim 2, wherein the headlamp includes two light-source supporting elements, both of the light-source supporting elements being positioned inside a single housing or each being positioned inside a respective housing, the headlamp including a fluid heat exchanger common to both light-source supporting elements or a separate fluid heat exchanger for each light-source supporting element.

20. Headlamp according claim 11, wherein the headlamp includes two light-source supporting elements, both of the light-source supporting elements being positioned inside a single housing or each being positioned inside a respective housing, the headlamp including a fluid heat exchanger common to both light-source supporting elements or a separate fluid heat exchanger for each light-source supporting element.
